(19) United States
(12) Patent Application Publication
(10) Pub. No.: US 2007/0089065 A1
(43) Pub. Date: Apr. 19, 2007

(54) Secondary navigation

(75) Inventors: Lisa M. Lane, Bellevue, WA (US); Jesper Kenneth Birk Olsen, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/252,270

(22) Filed: Oct. 17, 2005

(51) Int. Cl. G06F 9/00

(52) U.S. Cl. 715/764

(57) ABSTRACT

A secondary navigation system for navigating through a form allows a user to easily and quickly navigate through a plurality of features supported by the underlying application. The secondary navigation system provides quick access to context sensitive documents, document lists, features and services. An implementation of the secondary navigation system provides an always available secondary navigation menu including a task area and a find area in different sections of a user interface form in a manner so that a user can intuitively navigate through various features and services of an underlying application.

### BACKGROUND

Computers and computer software make up a very important part of modern life and business. Specifically, for any business organization to stay competitive, it is imperative that it uses computers and software applications to manage data, customers, employees, finances, etc. Businesses use a number of different software for virtually every function of their daily operations, such as payroll, customer relation management (CRM), accounting, inventory management, etc. Each of these various software applications generally use one or more underlying databases to store data and a number of graphical user interface (GUI) based forms to interact with the users. Depending on the business model, there may also be one or more intermediate layers operating between such database and the GUI forms presented to the end user.

In most data-centric applications, forms are the central place for entering and displaying data. For example, accounting software may use a form to present data related to a transaction to a user. Alternatively a form may also be used to allow a user to input data that will be processed by that accounting software and/or stored in the underlying database. For example, a purchase form may be presented to a user of the accounting system to allow the user to input information regarding purchase of an item. Such a purchase form may have various fields, including a general ledger account number, vendor information, an inventory account number if the purchased item is an inventory item, an expense account number if the purchase item is an expense item, a method of payment, a payment account number, etc. Each of the various fields that are displayed with the form may be attached to related tables in the database. The form may also be attached to one or more objects representing these fields.

Generally speaking, software applications perform a vast number of complex operations and a form may be used to interact with a user to guide the user to one or more of such operations. To make it easier for a user to access such operations in some logical manner, computer applications often provide navigation means that allows a user to navigate to the various operations. Using such navigation abilities, end users can select different items, tasks, etc., related to the underlying application. For example, a form used for an accounting application may navigate a user in a series of steps to a number of banking related operations, such as creating a new bank account, initiating bank account balances, making a payment, etc.

Generally speaking, the navigation menus follow a hierarchical order wherein selection of a particular control on the form may open a series of sub menus. An example of such a hierarchical navigation menu is a drop-down menu bar provided with, for example, a word processing application, where selecting a control on the drop-down menu opens a drop down list of choices, and wherein, often selecting one of the choices from the drop down list opens another drop down list to the left of or to the right of such a selected choice.

However, such hierarchical menus are not intuitive as it requires a user to remember the order of selections that the user will have to make to get to the ultimate function that the user may be interested in. Moreover, a number of operations that are commonly performed by users are not readily available on the navigation form, therefore, generally the user has to select a number of controls on the menu to reach the operation that the user is interested in. Therefore, using such menus can be extremely time consuming as the user has to manually go through each of the steps to get to the final selection.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A secondary navigation system for navigating and accessing an application's features, which are many times surfaced through a form, allows a user to easily and quickly navigate through a plurality of features supported by the underlying application. The secondary navigation system provides quick access to context sensitive documents, document lists, features and services. An implementation of the secondary navigation system provides an always available secondary navigation area within a graphical user interface (GUI) form, wherein the secondary navigation area includes a task menu and a find menu in a manner so that a user can intuitively navigate through various features, services and document lists of an underlying application.

An alternate implementation of the secondary navigation system provides a form navigation menu in a content area of the GUI form in a manner so that selecting one of the controls from the form navigation menu displays one of a plurality of forms in the content of the GUI form. Alternatively, the secondary navigation area of the GUI form may also provide a form filtering menu that may be used to generate a form related to an item selected from the secondary navigation area.

### BRIEF DESCRIPTION OF DRAWINGS

The present patent is illustrated by way of examples and not limitations in the accompanying figures, in which like references indicate similar elements, and in which:

FIG. 1 is a block diagram of a network interconnecting a plurality of computing resources;

FIG. 2 is a block diagram of a computer that may be connected to the network of FIG. 1;

FIG. 3 illustrates a conventional graphical user interface (GUI) form;

FIG. 4 illustrates a GUI form including a secondary navigation section having a task navigation menu and a find navigation menu;

FIG. 5 illustrates a GUI form including a secondary navigation section having a reports navigation menu; and

FIG. 6 illustrates a flowchart of a program used to implement the secondary navigation sections of FIGS. 4-5.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

### Network

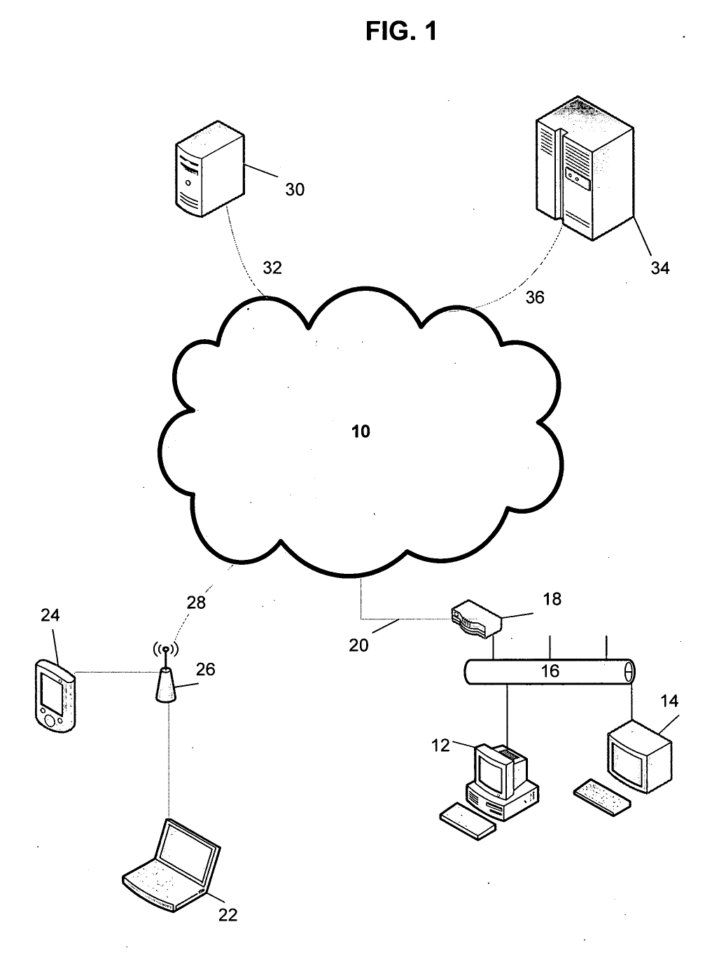

FIG. 1 illustrates a network 10 that may be used to implement a secondary navigation system described herein. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the secondary navigation system may be stored and operated on any of the various devices connected to the network 10. For example, the secondary navigation system described in here may display a graphical user interface form to a user on the personal computer 12, while the underlying application may run on the a remote server communicatively connected to the computer 12 via the network 10.

### Computer

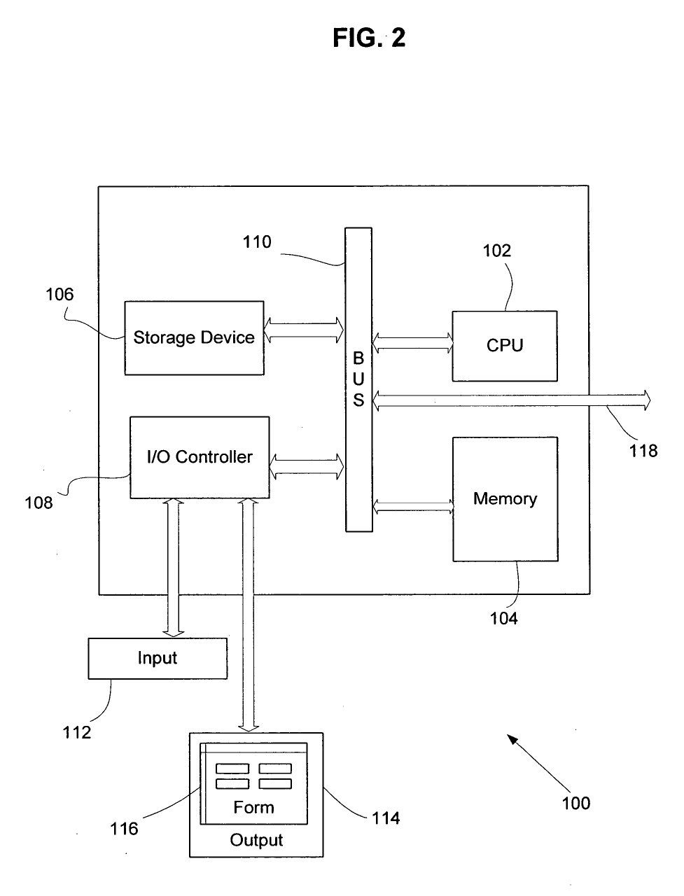

FIG. 2 illustrates a computing device in the form of a computer 100 that may be connected to the network 10 and used to implement one or more components of a secondary navigation system described herein. Components of the computer 100 may include, but are not limited to a central processing unit (CPU) 102, a memory 104, a storage device 106, an input/output controller 108, and a system bus 110 that couples various system components including the memory to the CPU 102. The system bus 110 may be any of several types of bus structures including a memory bus or memory controller, a peripheral bus, and a local bus using any of a variety of bus architectures.

The memory 104 may include computer storage media in the form of volatile and/or nonvolatile memory such as read only memory (ROM) and random access memory (RAM). A basic input/output system (BIOS), containing the basic routines that help to transfer information between elements within computer 110, such as during start-up, is typically stored in ROM. RAM typically contains data and/or program modules that are immediately accessible to and/or presently being operated on by processing unit 120. The memory 104 may also be used to store data related to one or more forms used by the computer 100.

The storage device 106 may typically include removable/non-removable, volatile/nonvolatile computer storage media. By way of example only, the storage device 106 may include a hard disk drive, a magnetic disk drive, nonvolatile magnetic disk 152, an optical disk drive, etc. One or more of the forms stored on the memory 104 may be populated using data stored on the storage device 106.

The I/O controller may be used by the computer 100 to communicate with an input device 112, which may be a keyboard, a mouse, etc., an output device 114, which may be a monitor, a printer, etc. The output device 114 is shown to display a form 116, which may be stored on the memory 104 and may be populated by data from the storage device 106. The secondary navigation system described herein may use the form 116 to interact with a user. A user may select one or more controls of the secondary navigation system described in here using the mouse, the keyboard, or any similar input device attached to the computer 100. The computer 100 may also be connected to the network 10 via an external communication bus 118.

### Secondary navigation System

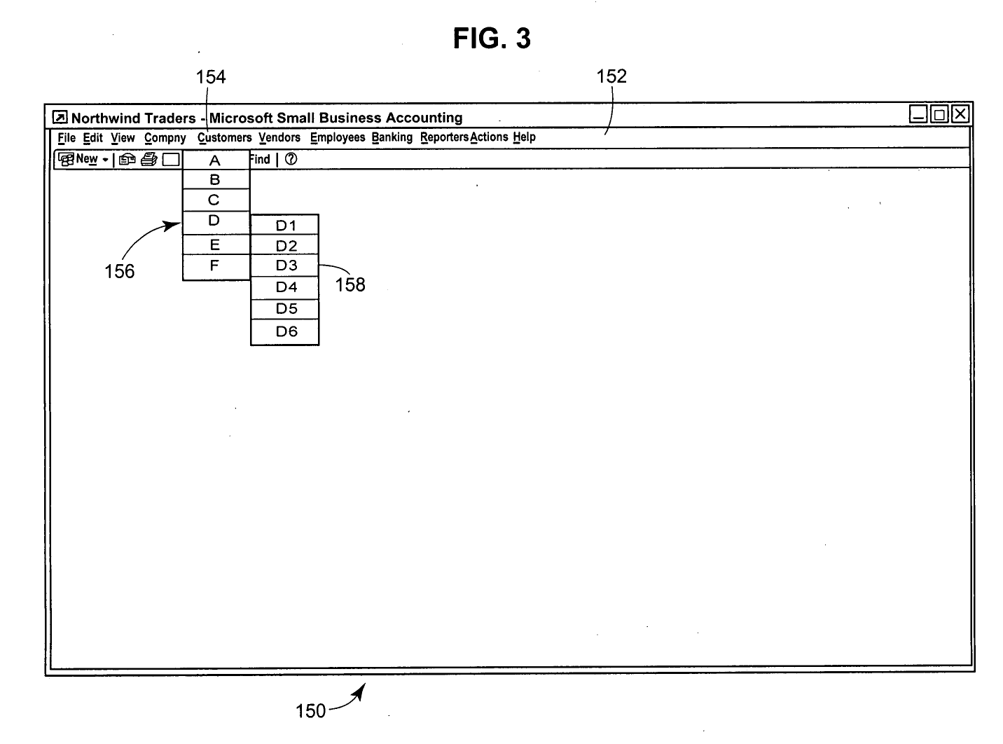

FIG. 3 is an illustration of a conventional graphical user interface (GUI) form 150, also known as a shell, which may be presented to a user by a computer application. The conventional GUI form 150 may include a content area 151 and a menu bar 152, wherein the menu bar 152 allows a user to select any of a plurality of controls listed horizontally. While the menu bar 152 is shown to be located horizontally and at the top, in an alternate embodiment the menu bar 152 may also be located at the bottom of the conventional GUI form 150, vertically aligned to the left edge or the right edge of the conventional GUI form 150. The number of controls and the names of the controls listed in the menu bar 152 depend on the application for which the conventional GUI form 150 is used.

Generally, a user can select one of the controls from the menu bar 152 by selecting that control using a mouse, by highlighting the control and then pressing the “Enter” key on a keyboard, or any other well known method. Upon selection of any of such controls, the menu bar 152 presents a drop-down menu with a plurality of additional controls. For example, when a user selects the “Customers” control 154 from the menu bar 152, a drop down menu 156 is presented to the user. The drop-down menu 156 provides a number of controls A-F and the user may select any of these controls by clicking on such a control using a mouse or keyboard.

As many computer applications have a vast number of different operations, it is often necessary that additional nesting of menus is used to navigate a user to the final operation that the user is interested in. Thus, in the illustrated example of the conventional GUI form 150, when the user selects the control “D” from the drop-down menu 156, another drop down menu 158 may be presented to the user, where the menu 158 may include controls D1-D6. As one of ordinary skill in the art would appreciate additional nesting of such drop down menus may also be necessary.

As one can see from the illustration of the conventional GUI form 150, when a user is interested in performing an operation D5, the user will have to select the “Customers” control 154 and then control D from the drop down menu 156. Such navigation using drop-down menus is time consuming. Moreover it is not intuitive to a user who may not know that the function D5 can be accessed by selecting the “Customers” control 154 and then the control D. In such a case, the user may have to try a number of other controls from the menu bar 152 and their drop down menus before getting to the operation that the user is interested in performing.

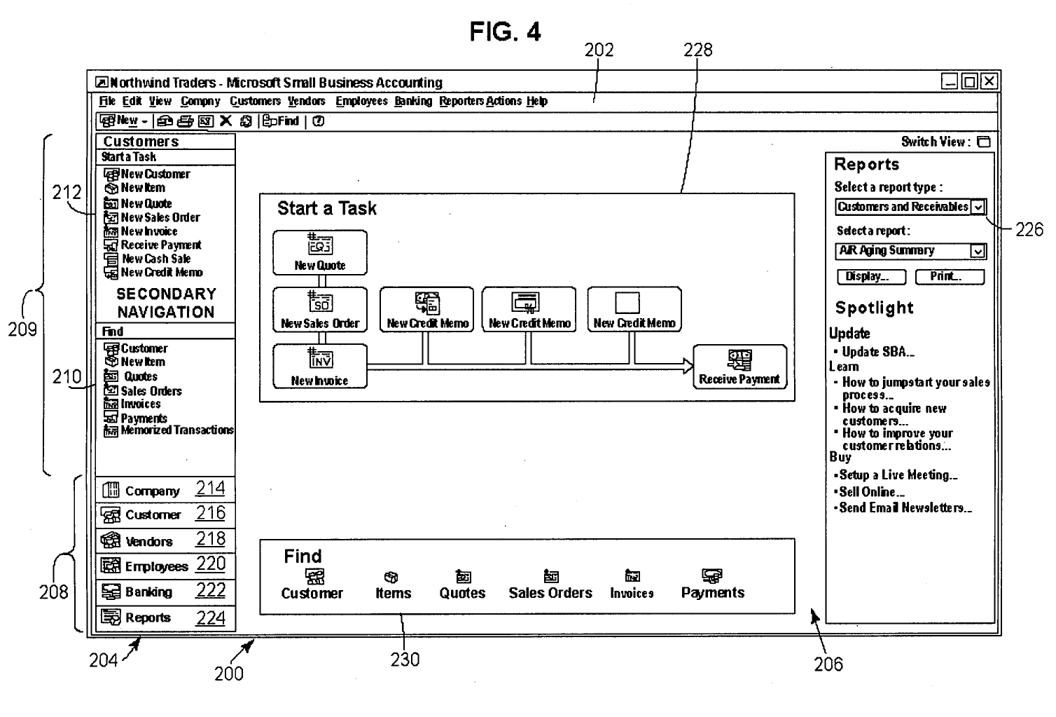

Now turning to FIG. 4, a modified GUI form 200 provides an improved user interface that may be used for interacting with an underlying computer application. The GUI form 200 may include a menu bar 202, a primary navigation area 204 and a content area 206. The menu bar 202 may function pretty much in the same manner as the menu bar 152 disclosed above in FIG. 3. The content area 206 may be used to display one or more reports, report filtering menus, or other controls based on the selection of control in the primary navigation area 204. Moreover, the GUI form 200 also includes a secondary navigation area 209, which may be located on top of the primary navigation area 204, as illustrated in FIG. 4. In the illustrated embodiment, the secondary navigation area 209 includes a find section 210 and a start-a-task section 212. However, in an alternate embodiment, the secondary navigation area may also include other menus or listings. Note that while in FIG. 4, the secondary navigation area 209 is illustrated to be located on top of the primary navigation area 204, in an alternate embodiment, it may be located to the left, to the right or below the primary navigation area 204. Additionally, in an alternate embodiment, a user may have an option to select the section of the form 200 in which the secondary navigation area 209 is to be positioned.

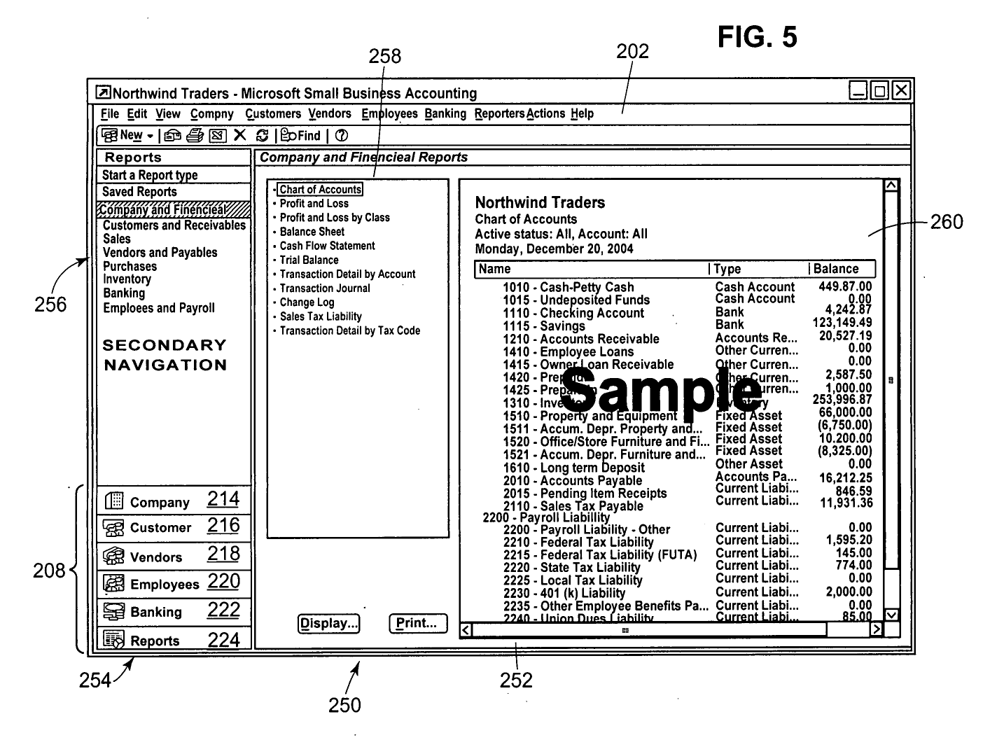

The primary navigation area 204 may includes a bucket listing section 208. Whereas the secondary navigation area 209 may be divided into mainly two different sections, namely the find section 210 and the start-a-task section 212. The bucket listing section 208 may include a number of controls listing a number of buckets containing various data related to the underlying application. When the GUI form 200 is activated the controls in the bucket listing section 208 are connected to the underlying data sources. For example, the GUI form 200 may include controls 214-222, each bucket corresponding to buckets for a company data source, a customers data source, a vendors data source, an employees data source and a banking data source, and each bucket connected to the respective data sources of the underlying application containing such data. Moreover, the bucket listing section 208 may also include a control 224 for reports, the function of which is discussed in further detail below with respect to FIG. 5. Note that while the GUI form 200 illustrated in FIG. 4 includes five buckets 214-224 in the bucket listing section 208, in an alternate implementation, higher or lower number of buckets may be listed.

When a user selects any of the controls 214-222, the GUI form 200 may display a number of other controls in both the content area 206 and in the secondary navigation area 209, where each of such newly displayed controls may be related to the particular controls 214-222 selected by the user. For example, as illustrated in FIG. 4, when a user selects the “Customers” control 216, the GUI form 200 may display various tasks related to the Customers bucket in the start-a-task area 212 and various listings related to the customers bucket in the find area 210.

Each of the task controls listed in the start-a-task area 212 may be implemented so as to activate some underlying computer code that is designed to launch a graphical listing or a table listing related to the selected task in the content area 204, or to launch a new single document interface (SDI) form related to the selected task. Thus, for example, when a user selects a “New Customer” task control in the start-a-task area 212, a graphical or a table listing of various options controls related to the “New Customer” task may be listed in the content area 204. Alternatively, when a user selects the “New Customer” task from the start-a-task area 212, a new SDI form (not shown here) may be launched that allows a user to create a new customer entity. On the other hand, each of the listing in the find area 210 may be implemented so as to activate some underlying computer code that is designed to generate a selected listing. Thus, for example, the GUI form 200 may be designed in a manner so that upon selecting a listing from the find area 210, such a listing is displayed in the content area 206. Alternatively, when a user selects the “Customers” listing, a new window with an SDI form listing the customers may be launched. [Note that, as per our conversation, I have changed the order of the above two sentences compared to the prior draft].

Moreover, when a user selects any of the controls 214-222, the GUI form 200 may also display a reports filtering navigation 226 in the content area 206. The reports filtering navigation 226 may include a first drop down menu that allows a user to filter all the report types for all the buckets, and a second drop down menu that allows a user to filter all the reports related to the selected type of bucket.

Besides generating such secondary navigation menus in the start-a-task area 212 and the find area 210, the GUI form 200 may also display a logical relationship tree 228 of the various tasks and a listing 230 related to the bucket selected in the bucket listing section 208 in the content area 206.

Now turning to FIG. 5, another modified GUI form 250 provides an alternate interface to the underlying application. At least some of the objects in the GUI form 250 are similar to the corresponding objects from the GUI form 200 and therefore are identified with the same numerals. For example, both of the GUI forms 200 and 250 have a drop down menu bar 202 on the top and a plurality of controls in the bucket listing section 208, wherein each of the controls 214-222 is related to one of the buckets 214-22 and the reports control 224 is used to activate the reports filtering navigation 226.

Specifically, the GUI form 250 illustrates the functioning of the secondary navigation system when the reports control 224 is selected by a user. The GUI form 250 may include a primary navigation area 254 including the bucket listing section 208 and a secondary navigation area 256 on top of the primary navigation area 254 and a content area 252 to the right of the primary navigation area 254. Note that while in FIG. 5, the primary navigation area 254 is illustrated to be to the left of the content area 252, in an alternate embodiment, it may be located to the right, of the content area 252. Similarly, while in FIG. 5, the secondary navigation area 256 is located on top of the primary navigation area 254, in an alternate embodiment the secondary navigation area 256 may be located below, to the right or to the left of the primary navigation area 254. The primary navigation area 254 may include the bucket listing section 208 with a plurality of controls 214-224, wherein the controls 214-222 are used to activate secondary navigation related to one of the plurality of buckets, while the reports control 224 may be used to activate a reports menu 256 in the secondary navigation area 256 located on top of the primary navigation area 254.

The reports menu 256 may list various categories of reports related to the underlying application. For example, FIG. 5 illustrates list of categories reports, including company and financial reports, sales reports, inventory reports, etc. When a user selects one of these categories, the GUI form 250 may illustrate a list of reports for the selected category in the content area 252. For example, in FIG. 5, a user has selected the “Company and Financial” category of reports, in response to which a listing of reports 258 may be displayed in the content area 252. Subsequently, the user can select any one of the reports from the listing of reports 258. For example, FIG. 5 illustrates that a user has selected the “Chart of Accounts” report to be displayed and in response to such selection, the “Chart of Accounts” report in displayed in a window 260 of the content area 252.

Note that a user can select any of the controls from the bucket listing section 208, from the category of reports 256, and from the listing of reports 258 using a number of different methods. For example, a user can highlight a particular choice and hit the Enter key, double-click a particular choice, or right click on a particular choice to activate the particular choice. Moreover, a user can also select the reports control from the drop down menu 202 to cause the category of reports 256 to be displayed in the secondary navigation area 209 located on top of the primary navigation area 254.

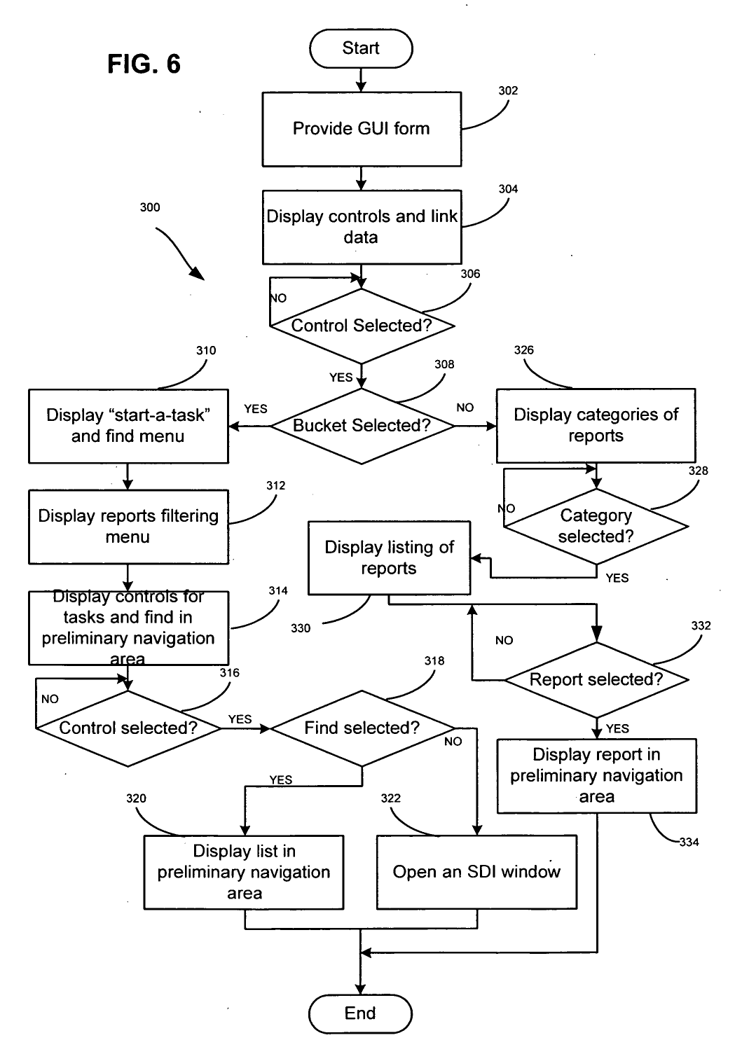

Now turning to FIG. 6, a flowchart of a program 300 illustrates a method of providing secondary navigation to a user in a GUI form such as the GUI forms described in FIGS. 3-5. The program 300 may be implemented on any computer on the network 10 that is communicatively connected to a display on which the GUI form is to be presented to the user. The program 300 may also be communicatively connected to a computer or a server that contains the data related to the underlying application for which the GUI form is used. A block 302 provides a GUI form to the user to start the secondary navigation.

Subsequently a block 304 may display the plurality of controls in the bucket listing section 208. Each of the various controls listed in the bucket listing section 208 may be linked to a source of data related to the underlying application. For example, in an implementation of the program 300, the block 304 may list buckets for company, customers, vendors, employees and banking related data. Such exemplary listing of buckets 214-222 is also illustrated in FIGS. 4 and 5. In an alternate implementation, other buckets may also be listed. Moreover, the block 304 may also display a reports control, such as the reports control 224 which may be used to activate secondary navigation of reports, as illustrated below in further detail.

Once the GUI form and the controls are presented to the user, a block 306 waits for an instruction from a user to see if any of the controls that should activate secondary navigation are selected. If any of such controls is selected, for example, by using the mouse, the keyboard, or in any other manner, a block 308 determines if any of the controls related to the buckets, such as the controls 214-222 is selected. If the control selected at block 306 is a bucket control, such as one of the controls 214-222, the block 038 may pass control to a block 310.

The block 310 may display a “start-a-task” menu and a find menu in the secondary navigation area 209 of the GUI form. For example, FIG. 4 shows the “start-a-task” menu 212 and the find menu 210, which are displayed in section of the secondary navigation area 209 located above the primary navigation area 204. As shown in FIG. 4, the start-a-task” menu 212 may list a number of tasks that may be performed by the user whereas the find menu 210 may display a number of lists that may be displayed by the user. Thus, for example, to enter a new invoice, a user may select the “New Invoice” choice from the start-a-task” menu 212. On the other hand if the user wants to find a particular customer, the user may select the “Customers” choice from the find menu 210.

Subsequently, a block 312 may display a reports filtering menu, such as the reports filtering navigation 226, in the content area 206. The functioning of the reports filtering navigation 226 is discussed in further detail above with respect to FIG. 4. Subsequently, a block 314 may display a relationship diagram including each of the choices from the start-a-task menu 212. Such a relationship diagram of various tasks is also illustrated by the logical relationship tree 228 in FIG. 4. The block 314 may also list each of the choices from the find menu 210 in the content area 206, as illustrated by the listing 230 in FIG. 4.

Subsequently, a block 316 may monitor if any of the controls from the menus 210-212, from the logical relationship tree 228 and from the listing 230 is selected by a user. If such a control is selected, block 318 may determine whether the selected control is one of the “Find” control or one of the “Start-a-Task” control. If the block 318 determines that one of the “Find” control, such as a control from the find menu 210 or from the listing 230 is selected, the control is transferred to a block 320. Subsequently, the block 320 may display a listing of items for the selected list in the content area 206 or 252. For example, if the selected control is a Payments control, a listing of all the payments for a default period may be displayed in the content area 206.

However, if the block 318 determines that one of the “Start-a-Task” controls, such as a control from the “Start-a-Task” menu 210 or from the logical relationship tree 228 is selected, the control is transferred to a block 322. Subsequently, the block 322 may open a new single document interface (SDI) form that allows a user to perform the selected task. For example, if the user selects the “New Payment” option from the logical relationship tree 228, a new SDI form may be presented to the user that allows the user to make a payment.

Note that in the above description of the program 300, the blocks 310-314 are shown to perform a series of functions in response to selection of one of the bucket controls 214-222. While these functions are shown to be performed in separate blocks, in an alternate implementation, they all may be shown to be performed by a single block. Moreover, the order of these blocks may also be changed.

If the control selected at block 306 is not a bucket control, the block 308 may determine that the reports control 224 is selected, and the control passes to a block 326. The block 326 may display a menu including various categories of reports, such as the reports menu 256, in the content area 206 or 252. Subsequently, a block 328 may determine if any of the categories from the reports menu 256 is selected by a user. If it is determined that a category from the reports menu 256 is selected, a block 330 may display a listing of reports related to the selected category in the content area 206 or 252. For example, in FIG. 5, if the “Company and Financial” category is selected from the reports menu 256, the listing of reports 258 related to the “Company and Financial” category may be displayed in the content area 206 or 252.

Subsequently, a block 332 may determine if any of reports from the listing of reports 258 is selected by a user. If it is determined that a report from the listing of reports 258 is selected, a block 334 may display the selected report in the content area 206 or 252. Thus, for example, in FIG. 5, if the “Chart of Accounts” report is selected by the user, the chart of accounts report 260 may be displayed in the content area 206 or 252.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of providing a graphical user interface (GUI) form for displaying data from a plurality of buckets, the method comprising:
providing the GUI form with a content area to display the content from at least one of the plurality of buckets;
providing the GUI form with a plurality of controls in a primary navigation area, each of the plurality of controls corresponding to one of the plurality of buckets;
receiving an input from a user selecting one of the plurality of controls; and
in response to selection of one of the plurality of controls, displaying in a secondary navigation area (1) a start-a-task menu allowing a user to activate a plurality of tasks related to the selected control, and (2) a find menu allowing a user to activate a plurality of item lists related to the selected control.

2. A method of claim 1, further comprising, in response to selection of one of the plurality of controls, displaying a graphical representation of relationship between the plurality of tasks in the content area of the form.

3. A method of claim 1, further comprising, in response to a selection of one of the plurality of tasks from the secondary menu, opening a single document interface form related to the selected task.

4. A method of claim 1, further comprising, in response to a selection of one of the plurality of item lists, displaying a list of items related to the selected item list in the content area.

5. A method of claim 1, wherein the plurality of controls includes a reports selection control and the method further comprises, in response to selection of the reports selection control, displaying a reports menu in the secondary navigation area allowing a user to filter a plurality of reports related to the selected control.

6. A method of claim 1, further comprising, in response to selection of one of the plurality of controls, displaying a reports filtering menu in the content area, wherein the reports filtering menu allows a user to filter a plurality of reports related to the selected control.

7. A method of claim 6, wherein the reports filtering menu comprises: (1) a first drop down menu providing access to reports related to each of the plurality of buckets, and (2) a second drop down menu providing access to reports related to the selected control.

8. A method of claim 1, wherein the GUI form is used to display data from a plurality of buckets of an accounting application and wherein the plurality of buckets includes at least one of: (1) a company related bucket, (2) a customers bucket, (3) a vendors bucket, (4) an employees bucket, (5) a banking bucket, and (6) [list other buckets to be included].

9. A computer-readable medium containing computer code for interfacing with a user of a computer system, said computer system having a user input and selection device and a processor capable of executing computer code, the computer code causing the computer system, when executed by the processor, to perform the steps of:
providing a GUI form with a content area to display the content from at least one of the plurality of buckets;
providing the GUI form with a plurality of controls in a primary navigation area, each of the plurality of controls corresponding to one of the plurality of buckets;
receiving an input from a user selecting one of the plurality of controls; and
in response to selection of one of the plurality of controls, displaying in a secondary navigation area (1) a start-a-task menu allowing a user to activate a plurality of tasks related to the selected control, and (2) a find menu allowing a user to activate a plurality of item lists related to the selected control.

10. The computer-readable medium of claim 9, wherein the computer code is further adapted to, in response to selection of one of the plurality of controls, displaying a graphical representation of relationship between the plurality of tasks in the content area of the form.

11. The computer-readable medium of claim 9, wherein the computer code is further adapted to, in response to a selection of one of the plurality of tasks from the secondary menu, opening a single document interface form related to the selected task.

12. The computer-readable medium of claim 9, wherein the computer code is further adapted to, in response to a selection of one of the plurality of item lists, displaying a list of items related to the selected item list in the content area.

13. The computer-readable medium of claim 9, wherein the plurality of controls includes a reports selection control and wherein the computer code is further adapted to, in response to selection of the reports selection control, displaying a reports menu in the secondary navigation area allowing a user to filter a plurality of reports related to the selected control.

14. The computer-readable medium of claim 9, wherein the computer code is further adapted to, in response to selection of one of the plurality of controls, displaying a reports filtering menu in the content area, wherein the reports filtering menu allows a user to filter a plurality of reports related to the selected control.

15. A graphical user interface (GUI) form for displaying data from a plurality of buckets related to a computer application running on a computer system, said computer system having a processor suitable for controlling a user display and retrieving input from a user input device, said GUI comprising:
a content area for displaying data from at least one of the plurality of buckets; and
a primary navigation area adapted to:
display a plurality of controls, each of the plurality of controls related to one of the plurality of buckets and adapted to receive an activation command from a user, and
in response to selection of one of the plurality of controls, display in a secondary navigation area (1) a start-a-task menu allowing a user to activate a plurality of tasks related to the selected control, and (2) a find menu allowing a user to activate a plurality of item lists related to the selected control.

16. A graphical user interface (GUI) form of claim 15, wherein the primary navigation area is further adapted to:
display a reports activation control, and
in response to selection of the reports activation control, display a reports menu in the secondary navigation area allowing a user to filter a plurality of reports related to the selected control.

17. A graphical user interface (GUI) form of claim 15, wherein the content area is further adapted to, in response to selection of one of the plurality of controls, display a graphical representation of relationship between the plurality of tasks in the secondary navigation area of the form.

18. A graphical user interface (GUI) form of claim 15, further adapted to, in response to a selection of one of the plurality of tasks from the start-a-task menu, opening a single document interface form related to the selected task.

19. A graphical user interface (GUI) form of claim 15, wherein the content area is further adapted to, in response to a selection of one of the plurality of item lists, displaying a list of items related to the selected item list in the content area.

20. A graphical user interface (GUI) form of claim 15, wherein the content area is further adapted to, in response to selection of one of the plurality of controls, displaying a reports filtering menu in the content area, wherein the reports filtering menu allows a user to filter a plurality of reports related to the selected control.
